(19) United States
(12) Patent Application Publication
(10) Pub. No.: US 2017/0301028 A1
(43) Pub. Date: Oct. 19, 2017

(54) PROCESSING SYSTEM TO GENERATE ATTRIBUTE ANALYSIS SCORES FOR ELECTRONIC RECORDS

(71) Applicants: Gregory David Strabel, West Hartford, CT (US); Ludwig Steven Wasik, West Hartford, CT (US); Shane Eric Barnes, Avon, CT (US); Laura J. Walker, Marcy, NY (US); Ian M. McHone, Charlotte, NC (US)

(72) Inventors: Gregory David Strabel, West Hartford, CT (US); Ludwig Steven Wasik, West Hartford, CT (US); Shane Eric Barnes, Avon, CT (US); Laura J. Walker, Marcy, NY (US); Ian M. McHone, Charlotte, NC (US)

(21) Appl. No.: 15/098,047

(22) Filed: Apr. 13, 2016

(51) Int. Cl. G06Q 40/08; G06F 17/30; G06N 99/00

(52) U.S. Cl. CPC G06Q 40/08; G06N 99/005; G06F 17/3053; G06F 17/30598

(57) ABSTRACT

A data store may contain electronic records representing a plurality of potential associations and, for each potential association, an electronic record identifier and a set of attribute values. An automated electronic record classification computer may classify electronic records from the data store into sub-sets of related records. An automated scoring analysis computer may retrieve, for each electronic record in a classified sub-set, the set of attribute values and calculate at least one attribute analysis score (based on attribute values of other electronic records in the same sub-set). A back-end application computer server may retrieve attribute values along with an attribute analysis score associated with an electronic record of interest and automatically retrieve third-party data. Data associated with an interactive user interface display, including the at least one attribute analysis score and the third-party data, may then be via a distributed communication network.

### BACKGROUND

In some cases, a performance value associated with an enterprise system may depend at least in part on attribute values of electronic records representing a plurality of potential associations with the enterprise system. For example, the performance value might tend to increase when a specific type of attribute value increases (or decrease when another type of attribute value increases). Moreover, an accurate prediction of the performance value may be desired. Manually making predictions and/or decisions about the performance value, however, can be a time consuming and error prone process, especially when a substantial number of electronic records and/or attribute variables may influence the behavior of the system. Note that different electronic records sharing certain characteristics might be classified together to improve the decision making process. This approach, however, cannot be practically implemented manually (e.g., because of the large number of characteristics and/or potential classifications involved). Similarly, a large and diverse amount of third-party information might further complicate these tasks. Note that improving the performance of the system and/or the accuracy of decisions made about potential associations might result in substantial improvements to the operation of the enterprise and/or one or more networks associated with the enterprise (e.g., by reducing an overall number of electronic messages that need to be created and transmitted via the network).

It would be desirable to provide systems and methods to automatically classify and create attribute analysis scores for electronic records in a way that provides faster, more accurate results and that allows for flexibility and effectiveness when responding to those results.

### SUMMARY OF THE INVENTION

According to some embodiments, systems, methods, apparatus, computer program code and means are provided to automatically classify and create attribute analysis scores for electronic records in a way that provides faster, more accurate results and that allow for flexibility and effectiveness when responding to those results. In some embodiments, a data store may contain electronic records representing a plurality of potential associations and, for each potential association, an electronic record identifier and a set of attribute values. An automated electronic record classification computer may classify electronic records from the data store into sub-sets of related records. An automated scoring analysis computer may retrieve, for each electronic record in a classified sub-set, the set of attribute values and calculate at least one attribute analysis score (based on attribute values of other electronic records in the same sub-set). A back-end application computer server may retrieve attribute values along with an attribute analysis score associated with an electronic record of interest and automatically retrieve third-party data. Data associated with an interactive user interface display, including the at least one attribute analysis score and the third-party data, may then be via a distributed communication network.

Some embodiments comprise: means for accessing, by an automated electronic record classification computer, a data store containing electronic records representing a plurality of potential associations with the enterprise and, for each potential association, an electronic record identifier and a set of attribute values; means for classifying, by an automated electronic record classification computer, electronic records into sub-sets of related records; means for storing, by the automated electronic record classification computer, indications of the classified sub-sets of related records; means for retrieving, by an automated scoring analysis computer for each electronic record in a classified sub-set, the associated set of attribute values; means for calculating, by the automated scoring analysis computer, at least one attribute analysis score for each electronic record based on sets of attribute values associated with other electronic records classified in the same sub-set; means for storing, by the automated scoring analysis computer, an indication of the attribute analysis score for each electronic record; means for receiving, by a back-end application computer server, an indication of an electronic record of interest; means for accessing, by the back-end application computer server, the data store to retrieve the set of attribute values along with the at least one attribute analysis score associated with the electronic record of interest; means for automatically retrieving, by the back-end application computer server, third-party data based at least in part on the electronic record of interest; and means for transmitting, by the back-end application computer server via a communication port, data associated with an interactive user interface display, including the at least one attribute analysis score and the third-party data, via a distributed communication network.

In some embodiments, a communication device associated with a back-end application computer server exchanges information with remote devices. The information may be exchanged, for example, via public and/or proprietary communication networks.

A technical effect of some embodiments of the invention is an improved and computerized way to automatically classify and create attribute analysis scores for electronic records in a way that provides faster, more accurate results and that allow for flexibility and effectiveness when responding to those results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 illustrates a method according to some embodiments of the present invention.

FIG. 3 is an example of an electronic record scorecard policy search interactive user display according to some embodiments.

FIG. 4 is a high-level block diagram of an insurance underwriting system according to some embodiments.

FIG. 5 is an example of an electronic record scorecard attribute values and underwriting grades interactive user display according to some embodiments.

FIG. 6 is an example of an electronic record scorecard benchmarking definition interactive user display according to some embodiments.

FIG. 7 is an example of an electronic record scorecard policy detailed map user display according to some embodiments.

FIG. 8 is an example of an electronic record scorecard virtual tour interactive user display according to some embodiments.

FIG. 9 is an example of an electronic record scorecard geographical cohorts interactive user display according to some embodiments.

FIG. 10 is an example of an electronic record documentation interactive user display according to some embodiments.

FIG. 11 is a block diagram of an apparatus in accordance with some embodiments of the present invention.

FIG. 12 is a portion of a tabular resource allocation database in accordance with some embodiments.

FIG. 13 illustrates a system having a predictive model in accordance with some embodiments.

FIG. 14 illustrates a tablet computer displaying a resource allocation user interface according to some embodiments.

FIG. 15 illustrates an overall process in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of electronic record attribute analysis by providing benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks, and subsystems. For example, in the present invention information may be processed, automatically classified, forecast, and/or predicted via a back-end application server and results may then be analyzed accurately to evaluate the accuracy of various results and/or facilitate predictions associated with future performance, thus improving the overall efficiency of the system associated with message storage requirements and/or bandwidth considerations (e.g., by reducing the number of messages that need to be transmitted via a network). Moreover, embodiments associated with predictive models might further improve performance values, predictions of performance values, electronic record processing decisions, etc.

In some cases, a performance value associated with an enterprise system may depend at least in part on attribute values of electronic records representing a plurality of potential associations with the enterprise system. For example, the performance value might tend to increase when a specific type of attribute value increases (or decrease when another type of attribute value increases). Moreover, an accurate prediction of the performance value may be desired. Manually making predictions and/or decisions about the performance value, however, can be a time consuming and error prone process, especially when a substantial number of electronic records and/or attribute variables may influence the behavior of the system. Note that different electronic records sharing certain characteristics might be classified together to improve the decision making process. This approach, however, cannot be practically implemented manually (e.g., because of the large number of characteristics and/or potential classifications involved). Similarly, a large and diverse amount of third-party information might further complicate these tasks. Note that improving the performance of the system and/or the accuracy of decisions made about potential associations might result in substantial improvements to the operation of the enterprise and/or one or more networks associated with the enterprise (e.g., by reducing an overall number of electronic messages that need to be created and transmitted via the network).

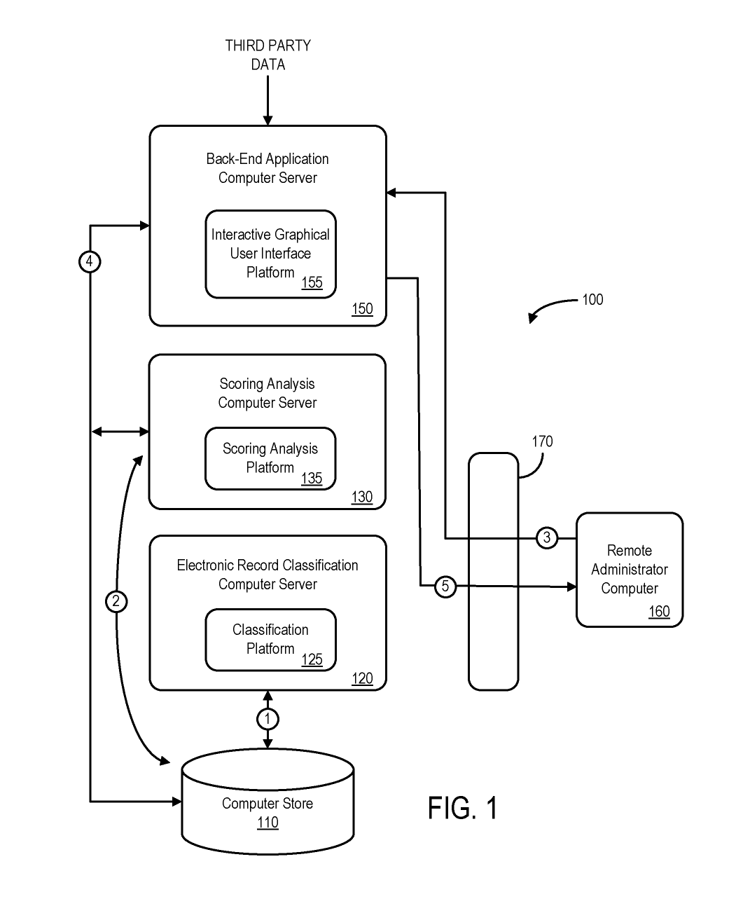

It would be desirable to provide systems and methods to automatically classify and create attribute analysis scores for electronic records in a way that provides faster, more accurate results and that allows for flexibility and effectiveness when responding to those results. FIG. 1 is a high-level block diagram of a system 100 according to some embodiments of the present invention. In particular, the system 100 includes a back-end application computer server 150 that may access information in a computer store 110 (e.g., storing a set of electronic records representing risk associations, each record including, for example, one or more communication addresses, attribute variables, etc.). The back-end application computer server 150 may also exchange information with a remote administrator computer 160 (e.g., via a firewall 170). According to some embodiments, an interactive graphical user interface platform 155 of the back-end application computer server 150 (and, in some cases, third-party data) may facilitate forecasts, decisions, predictions, and/or the display of results via the one or more remote administrator computers 160.

In addition to the back-end application computer server 150, an electronic record classification server 120 and a classification platform 125 may access information in the computer store 110 to classify electronic records into clusters that share certain characteristics. Moreover, a scoring analysis computer server 130 and scoring analysis platform 135 may access information in the computer store 110 to analyze attribute values associated with electronic records. Further note that the back-end application computer server 150 and/or any of the other devices and methods described herein might be associated with a third party, such as a vendor that performs a service for an enterprise.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate classification and/or analysis of electronic records in the computer store 110. As used herein, the term “automated” may refer to, for example, actions that can be performed with little (or no) intervention by a human.

As used herein, devices, including those associated with the back-end application computer server 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the computer store 110. The computer store 110 might, for example, store electronic records representing a plurality of potential associations, each electronic record having a set of attribute values. The computer store 110 may also contain information about past and current interactions with parties, including those associated with remote communication devices. The computer store 110 may be locally stored or reside remote from the back-end application computer server 150. As will be described further below, the computer store 110 may be used by the back-end application computer server 150 in connection with an interactive user interface. Although a single back-end application computer server 150 is shown in FIG. 1, any number of such devices may be included. Moreover, various devices described herein might be combined according to embodiments of the present invention. For example, in some embodiments, the back-end application computer server 150 and computer store 110 might be co-located and/or may comprise a single apparatus.

According to some embodiments, the system 100 may automatically facilitate an interactive user interface via the automated back-end application computer server 150. For example, at (1) the electronic record classification computer server 120 may access the computer store 110 to assign similar electronic records to sub-sets or “clusters” of records. Information about the sub-sets or clusters might then be stored back into the computer store 110. At (2), the scoring analysis computer server 130 may access the computer store 110 to analyze and/or assign scores to attributes associated with each electronic record (e.g., based on comparisons with other electronic records in the same sub-set or cluster). Information about the scores might then be placed back into the computer store 110.

At (3) the remote administrator computer 160 may provide inputs to the back-end application computer server 150, such as an indication of an electronic record that is of particular interest to an administrator. At (4), back-end application computer server 150 might retrieve information for that record of interest from the computer store 110 (along with, in some embodiments, third-party data. The interactive graphical user interface platform 155 may then use this information to transmit appropriate information to the administrator computer at (5).

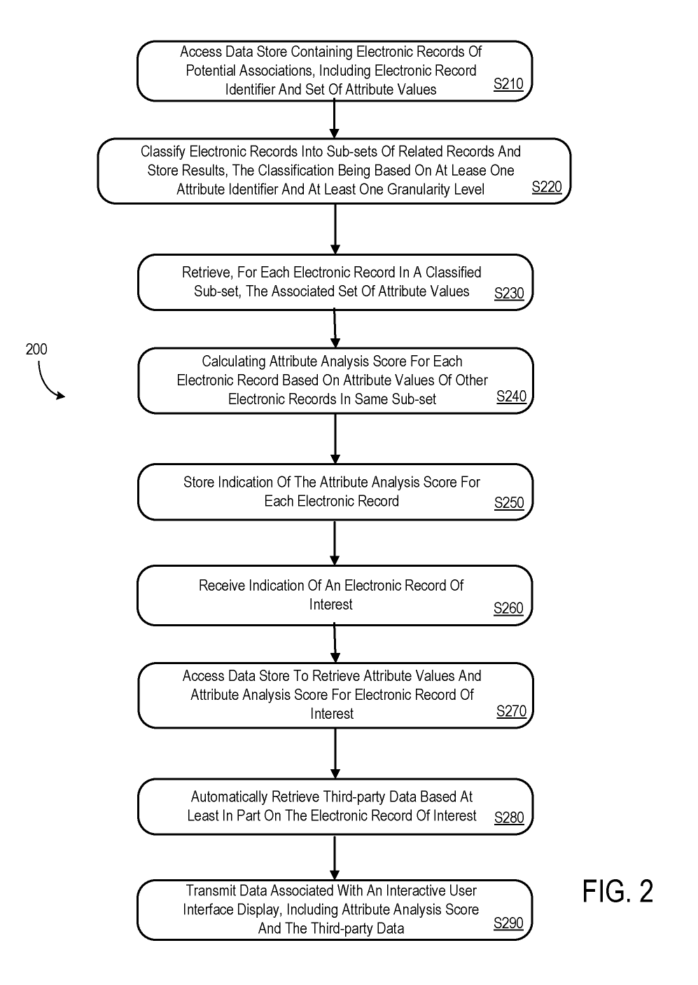

Note that the system 100 of FIG. 1 is provided only as an example, and embodiments may be associated with additional elements or components. According to some embodiments, the elements of the system 100 automatically transmit information associated with an interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may access a data store containing electronic records representing a plurality of potential associations with an enterprise and, for each potential association, an electronic record identifier and a set of attribute values.

At S220, an automated electronic record classification computer may classify electronic records from the data store into sub-sets of related records based on at least one attribute identifier and at least one granularity level, and the indications of the classified sub-sets of related records may be stored. According to some embodiments, this classification of electronic records into sub-sets of related records is performed in accordance with a clustering process based on an attribute identifier and a granularity level selected by a user via an interactive display interface. In some embodiments, the clustering process might be associated with a “k-means clustering” machine learning algorithm. As used herein, the phrase “k-means clustering” might refer to, for example, a method of vector quantization that aims to partition n observations into k clusters in which each observation belongs to the cluster with the nearest mean, serving as a prototype of the cluster. Some embodiments may be associated with expectation-maximization algorithms for mixtures of Gaussian distributions via an iterative refinement approach employed by both algorithms. Given a set of observations (x₁, x₂, . . . , xₙ), where each observation is a d-dimensional real vector, k-means clustering may partition the n observations into k (≦n) sets S={S₁, S₂, . . . , Sₖ} to minimize the Inter-Cluster Sum of Squares (“ICSS”) (e.g., the sum of distance functions of each point in the cluster to the K center). In other words, the objective might be to find:

$${argmin}_{S} {\sum }_{i = 1}^{k} {\sum }_{x ∈ {S}_{i}} {‖ x - {µ}_{i} ‖}^{2}$$

where μᵢ is the mean of points in Sᵢ.

According to some embodiments, each electronic record is associated with a potential insurance policy (e.g., an insurance policy quote, an existing insurance policy, and/or an insurance policy renewal). In this case, the selected granularity level for clustering might be associated with, for example, a geographic cohort granularity (e.g., with policies in the same ZIP code, county, etc. being clustered together), an insurance agency granularity, a state granularity, and/or a market group granularity.

At S230, an automated scoring analysis computer may retrieve, for each electronic record in a classified sub-set, the associated set of attribute values. At S240, at least one attribute analysis score may then be calculated for each electronic record based on sets of attribute values associated with other electronic records classified in the same sub-set. For example, when each electronic record is associated with a potential insurance policy the attribute analysis score might be associated with an underwriting grade. In some cases, the attribute values might represent information about the insured associated with the insurance policy, such as an annual sales amount, an industry classification, and/or prior claim information (e.g., a historical number of claims or value of claims filed by the potential insured during prior years). Other examples of attribute values might be associated with information about the insurance policy, such as a property deductible amount, a business personal property limit, a building limit, and/or a building limit per square foot. Still other attribute values might represent information about a property associated with the insurance policy, such as a building area (in square feet), a building net rate, a construction type, a fire protection class, and/or a year the building was built. In other cases, the attribute values might be associated with a location associated with the insurance policy, such as a quality index, an earthquake zone, a wind zone, and/or a sub-wind zone. At S250, an indication of the attribute analysis score for each electronic record may be stored.

At S260, a back-end application computer server may receive an indication of an electronic record of interest. The indication of the electronic record of interest may be, for example, associated with an insurance policy search input. According to some embodiments, the insurance policy search input might represent an insurance policy number, a selected location, an insured name, an insurance policy description, and/or a building identifier. At S270, the system may access the data store to retrieve the set of attribute values along with the at least one attribute analysis score associated with the electronic record of interest. At S280, the system may automatically retrieve third-party data based at least in part on the electronic record of interest. The third party data might comprise, according to some embodiments, mapping data accessed via an Application Programming Interface (“API”).

At S290, a communication port coupled to the back-end application computer server may facilitate a transmission of data associated with an interactive user interface display, including the at least one attribute analysis score and the third-party data, via a distributed communication network. According to some embodiments, the interactive user interface display includes an interactive street level map dynamically created from the third party data. Moreover, as described herein the interactive user interface display might further include a plurality of benchmarking graphs, satellite image map information, and/or an interactive cluster display that can be adjusted by a user.

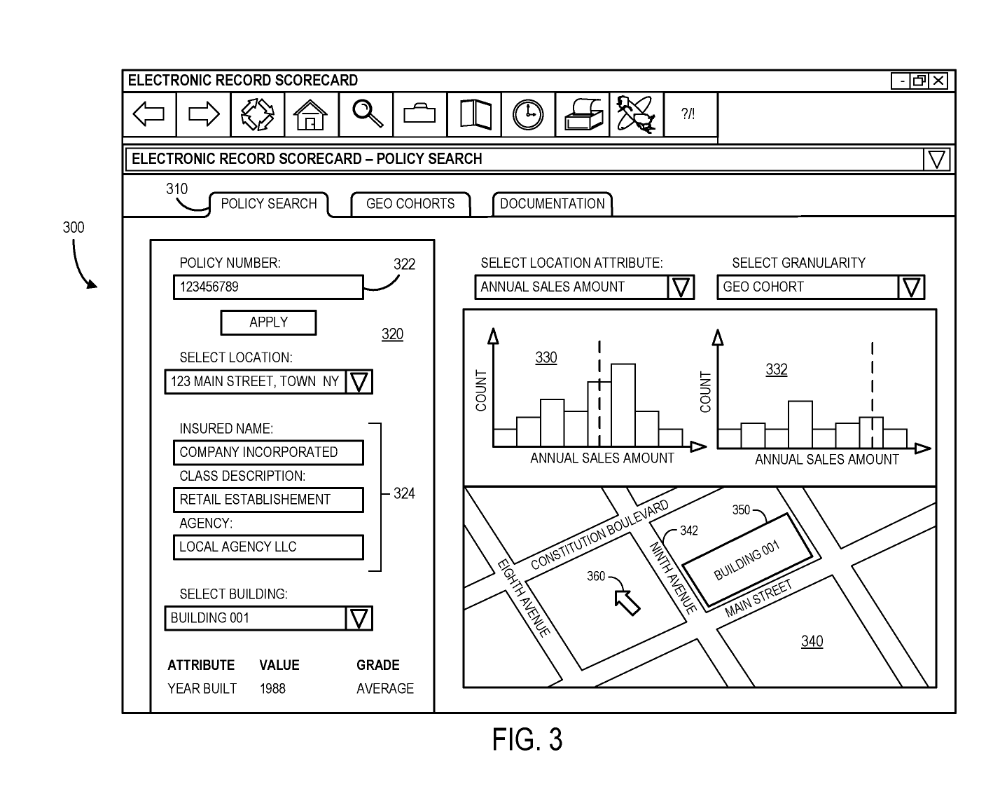

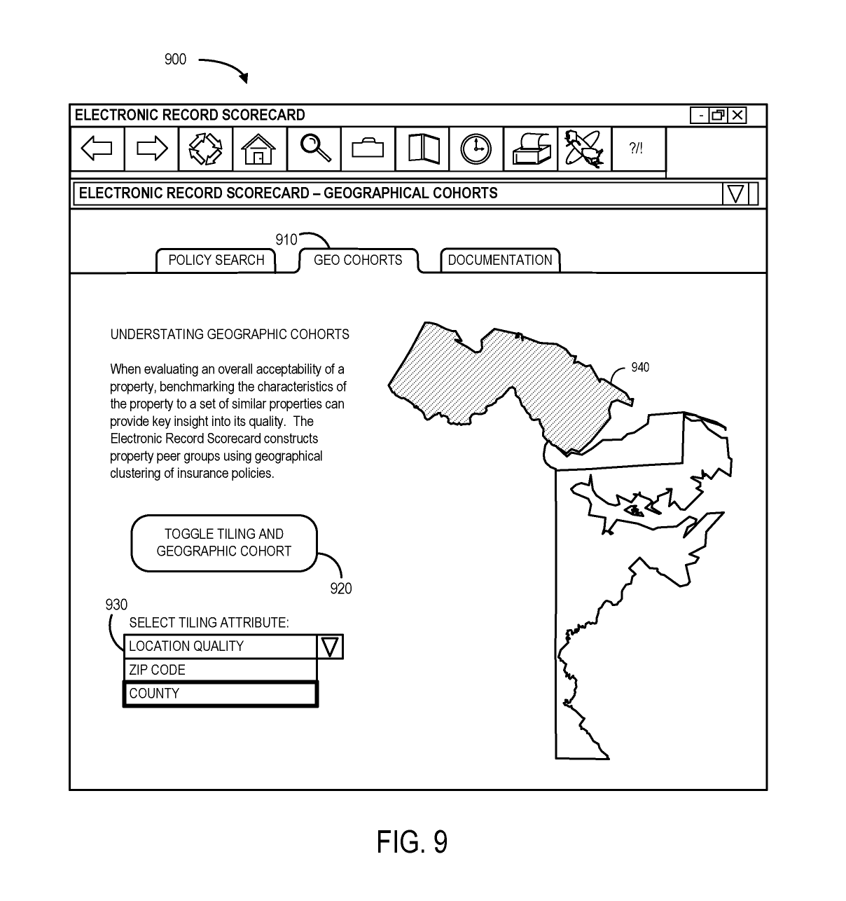

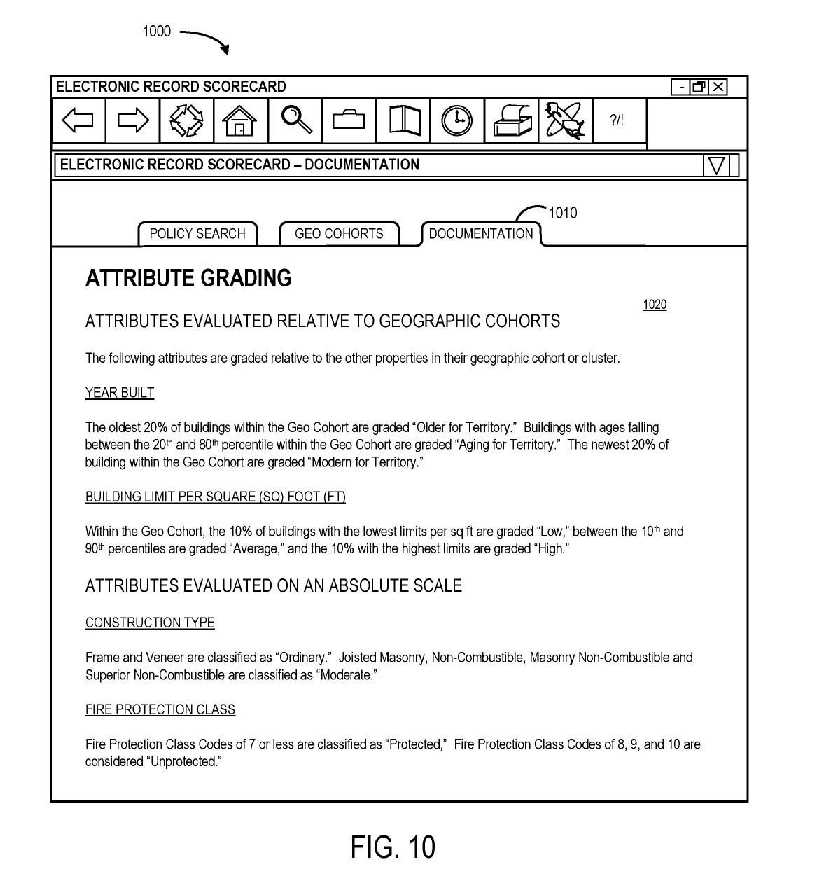

For example, FIG. 3 illustrates an electronic record scorecard policy search interactive user display 300 according to some embodiments. The display 300 includes a policy search tab 310 (selected in FIG. 3), a geographic (“geo”) cohorts tab (selected in FIG. 9), and a document tab (selected in FIG. 10). The display includes a first area 320 where an insurance policy number search term may be entered 322 (e.g., to let a user indicate a property of interest), a location may be selected, an insured name, class description, and insurance agency 324 may be entered and/or a building identifier may be selected (e.g., “Building 001”). The display 300 may further include a first benchmarking graph 330 (e.g., plotting a number of insurance policies (“count”) versus different value of an attribute (“annual sales amount,” etc.) for issued insurance policies) and a second benchmarking graph 332 (e.g., plotting a number of insurance policies versus different value of an attribute for unsuccessful insurance policy quotes). The graphs 330, 332 might, for example, let an underwriter quickly understand how a particular property compares to other, similar properties. The display 300 also includes a map area 340 that may provide third-party mapping information (e.g., from the GOOGLE® mapping platform) on a street-level 342 basis for the property of interest 350. A display pointer 360 might be used in the map area 340 to dynamically re-center the display, zoom in or out, etc.

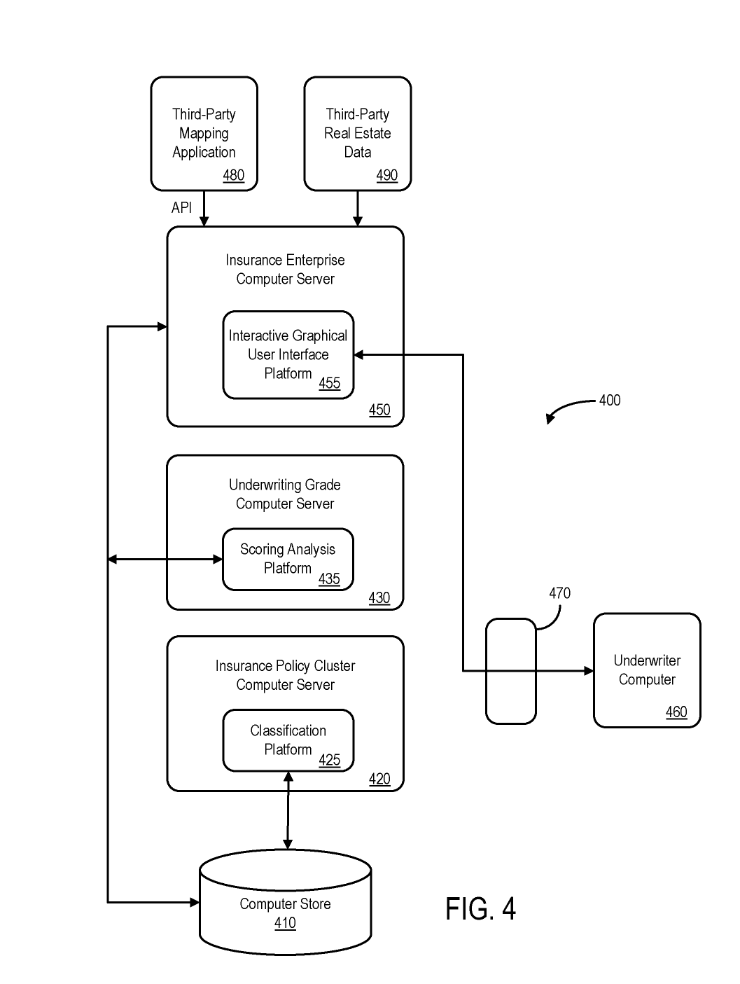

FIG. 4 is a high-level block diagram of an insurance underwriting system 400 according to some embodiments. Similar to the system 100 of FIG. 1, the underwriting system 400 includes an insurance enterprise computer server 450 that may access information in a computer store 410 (e.g., storing a set of electronic records representing potential insurance policies, each record including, for example, one or more addresses, attribute variables, etc.). The insurance enterprise computer server 450 may also exchange information with a remote underwriter computer 460 (e.g., via a firewall 470). According to some embodiments, an interactive graphical user interface platform 455 of the insurance enterprise computer server 450 (and, in some cases, data from a third-party mapping application 480 and/or third-party real estate data 490) may facilitate forecasts, decisions, predictions, and/or the display of results via the one or more remote underwriter computers 460.

In addition to the insurance enterprise computer server 450, an insurance policy cluster computer server 420 and a classification platform 425 may access information in the computer store 410 to classify insurance policies into clusters that share certain characteristics. Moreover, an underwriting grade computer server 430 and scoring analysis platform 435 may access information in the computer store 410 to analyze attribute values associated with insurance policies. Further note that the insurance enterprise computer server 450 and/or any of the other devices and methods described herein might be associated with a third party, such as a vendor that performs a service for an enterprise.

The insurance enterprise computer server 450 and/or the other elements of the system 400 might be, for example, associated with a PC, laptop computer, smartphone, an enterprise server, a server farm, and/or a database or similar storage devices. According to some embodiments, an automated insurance enterprise computer server 450 (and/or other elements of the system 400) may facilitate classification and/or analysis of electronic records in the computer store 410. As used herein, devices, including those associated with the insurance enterprise computer server 450 and any other device described herein may exchange information via any communication network which may be one or more of a LAN, a MAN, a WAN, a proprietary network, a PSTN, a WAP network, a Bluetooth network, a wireless LAN network, and/or an IP network such as the Internet, an intranet, or an extranet. Note that any devices described herein may communicate via one or more such communication networks.

The insurance enterprise computer server 450 may store information into and/or retrieve information from the computer store 410. The computer store 410 might, for example, store electronic records representing a plurality of potential insurance policies, each insurance policy having a set of attribute values. The computer store 410 may also contain information about past and current interactions with parties, including those associated with remote communication devices. The computer store 410 may be locally stored or reside remote from the insurance enterprise computer server 450. As will be described further below, the computer store 410 may be used by the insurance enterprise computer server 450 in connection with an interactive user interface. Note that in some embodiments, the insurance policy cluster computer server 420, the underwriting grade computer server 430, and/or the insurance enterprise computer server 450 might comprise a single, integrated computer or computing platform.

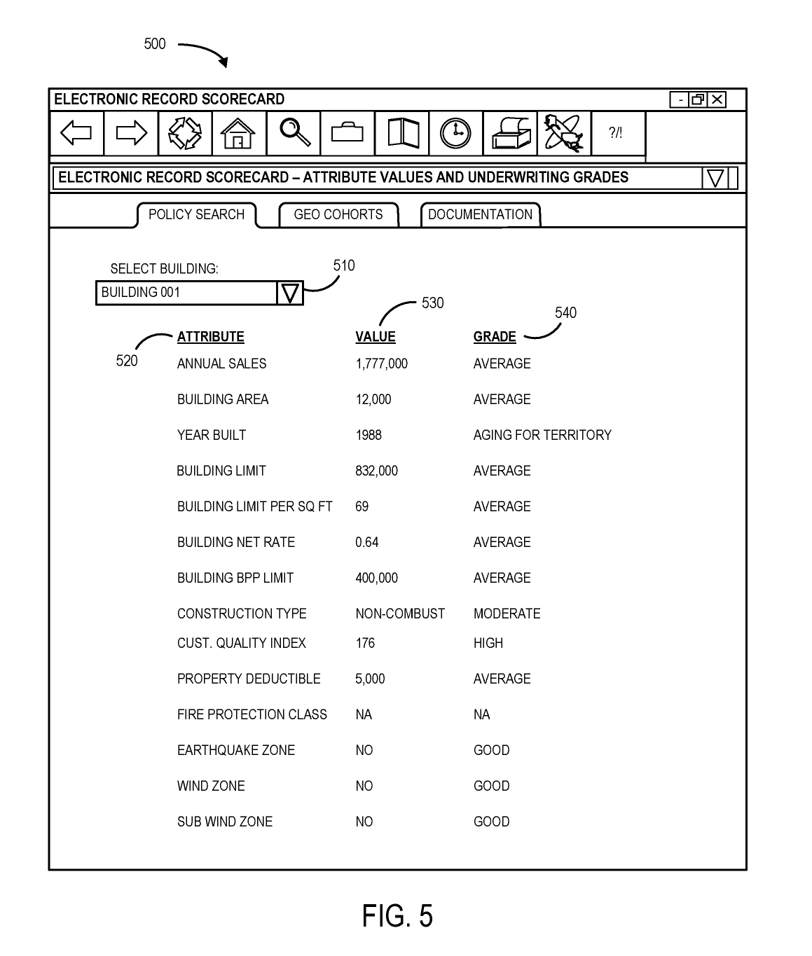

FIG. 5 is an example of an electronic record scorecard attribute values and underwriting grades interactive user display 500 according to some embodiments. For a selected building 510, the display includes attributes 520, attribute values 530, and associated attribute value grades 540. For example, the third row in FIG. 5 shows that “Building 001” has a “Year Built” value of “1988” which may be considered “Aging For Territory” (which an underwriter might use when making decisions about a potential insurance policy for Building 001). Note that the attribute value grades 540 might be absolute grades or grades relative to other properties and/or other insurance policies (e.g., the 10% oldest buildings sharing the same ZIP code might be designated as “Aging For Territory”).

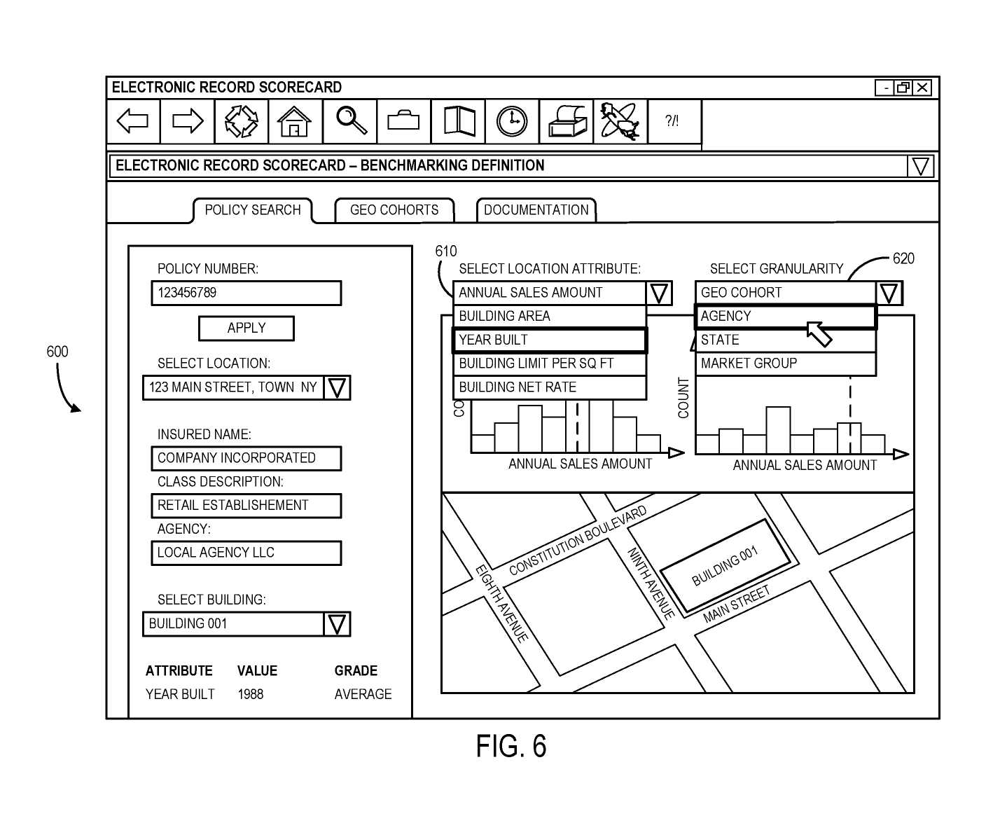

FIG. 6 is an example of an electronic record scorecard benchmarking definition interactive user display 600 according to some embodiments. Note that an underwriter might use such a display to examine information about similar insureds, properties and/or insurance policies. The display 600 might be used by the underwriter, according to some embodiments, to select a location attribute 610 (e.g., an annual sales amount, building area in square feet, year built, etc.) and a granularity 620 (e.g., geographic cohorts, insurance agency, state, and/or market group) that will be used to create such clusters of similar insureds, insurance policies, and/or properties. The clusters of similar policies and/or properties might then be used, for example, to update attribute value grades and/or benchmarking graphs.

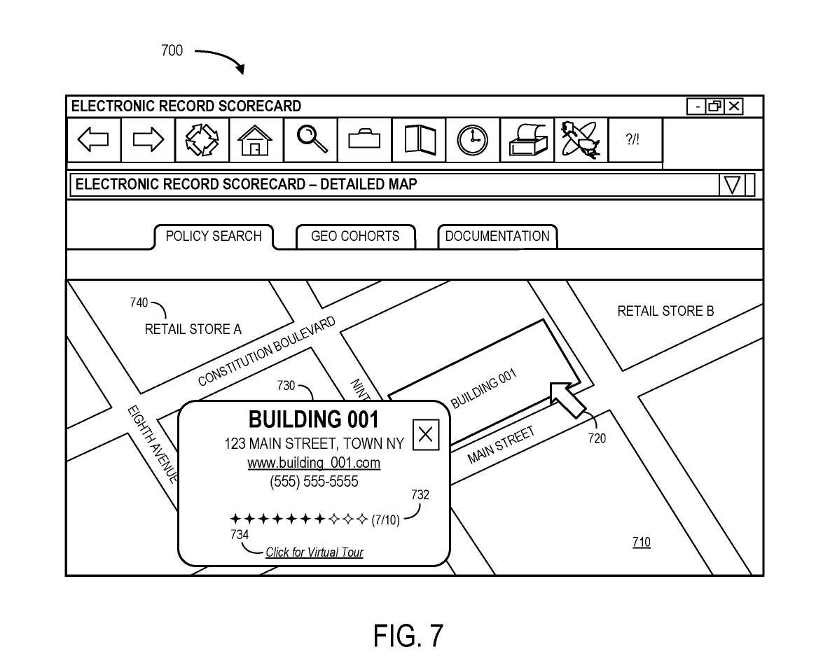

According to some embodiments, selection of the map area in the display 600 (e.g., the lower right portion of the display) might result in the presentation of more detailed third-party mapping data. For example, FIG. 7 is an example of an electronic record scorecard policy detailed map user display 700 according to some embodiments. The display 700 includes street level map data 710 (e.g., either drawn or rendered on the display 700 or taken from satellite image data). According to some embodiments, selection of a property with a computer pointer 720 may result in a pop-up window 730 being displayed with further information about that property. Moreover, the map data 710 may include information about nearby businesses, such as retail stores 740, restaurants, service providers, etc. This type of information may, for example, help an underwriter better understand a property being considered for insurance. The pop-up window 730 might include, for example, the name and address of the property, a web site URL link associated with the property, a telephone number, etc. According to some embodiments, the pop-up window 730 may further include social media information 730, including user reviews and/or ratings, user submitted comments and pictures, posts, etc.'

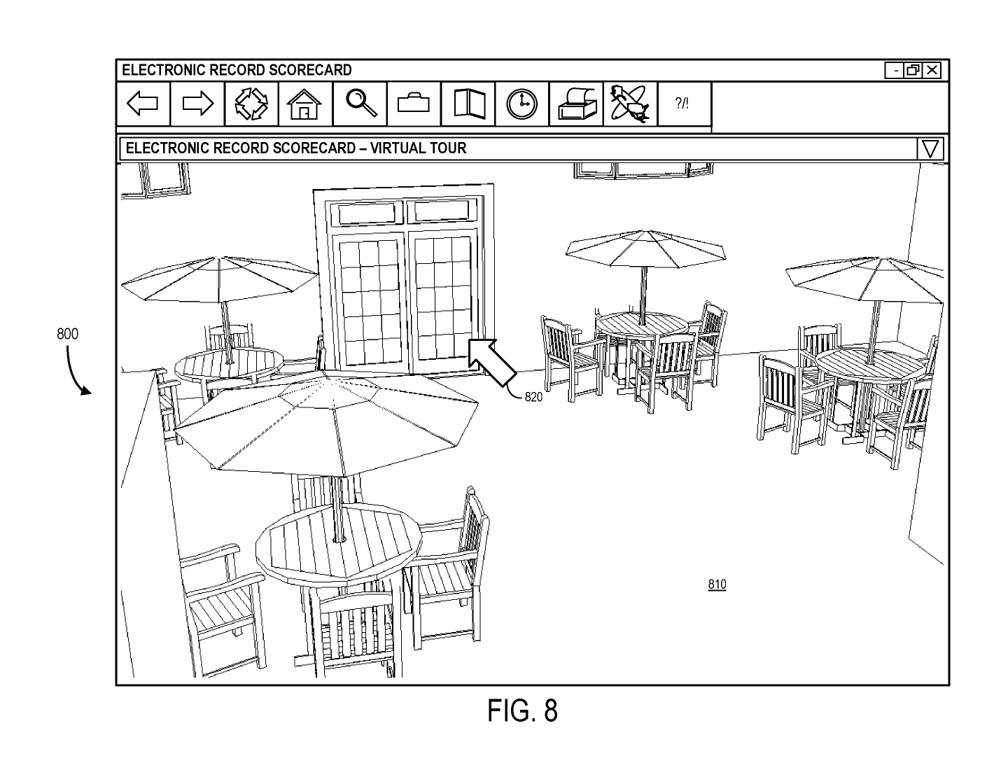

Moreover, the pop-up window 730 might include a link 734 that lets a user take a virtual tour of the property being displayed in connection with the map data 710. FIG. 8 is an example of an electronic record scorecard virtual tour interactive user display 800 according to some embodiments. The virtual tour interactive user display 800 may include a 3-D rendering 810 of, for example, a retail establishment associated with the property being evaluated by the underwriter. According to some embodiments, a 3-D rendering 810 of a neighboring establishment might also be viewable by a user. Although the 3-D rendering 810 is provided on a computer monitor in the example of FIG. 8, note that embodiments might instead use a virtual reality headset or any other type of display device. A user may manipulate a computer pointer 820 to move around within and/or interact with the virtual tour interactive user display 800. For example, the computer pointer 820 might be activated (e.g., “clicked”) over a window or door to move the tour to another room of the business. The computer pointer 820 might also be used, for example, to adjust the 3-D rendering 810 by performing an operation such as re-centering, rotating, zooming in or out, etc.

FIG. 9 is an example of an electronic record scorecard geographical (“geo”) cohorts interactive user display 900 according to some embodiments (that is, the geo cohorts tab 910 has been selected by the user). A user may select an icon 920 to toggle between tiling map and geographic cohort map displays 940. With respect to a tiling map display 940, a drop-down menu 930 may be used to select a tiling attribute, such as a location quality level tile, a ZIP code level tile, a county level tile, etc. Note that when evaluating an overall acceptability of a property that may be insured, benchmarking one or more characteristics of the property to a set of similar properties may provide key insights to the quality and risks associated with that property. According to some embodiments, the geographical cohorts interactive user display 900 utilizes property peer groups that are constructed using geographical clustering of insurance policies.

Attribute grades may be provided to help underwriters understand the quality and risks associated with a property that might be insured. FIG. 10 is an example of an electronic record documentation interactive user display 1000 according to some embodiments (that is, the documentation tab 1010 has been selected by the user). The documentation interactive user display 1000 may, for example, provide text 1020 that helps explain at least one underwriting grade that is generated by the system. The text 1020 might explain, for example, attributes that are evaluated relative to geographic cohorts and/or attributes that are evaluated on an absolute scale. An example of an attribute that is evaluated relative to geographic cohorts might be a “Year Built” value wherein: the oldest 20% of buildings within the Geo Cohort might be graded “Older for Territory”; buildings with ages falling between the 20th and 80th percentile within the Geo Cohort might be graded “Aging for Territory”; and the newest 20% of building within the Geo Cohort might be graded “Modern for Territory.” Another example might be a “Building Limit Per Square (SQ) Foot (FT)” value wherein: the 10% of buildings with the lowest limits per sq ft might be graded “Low;” between the 10th and 90th percentiles might be graded “Average;” and the 10% with the highest limits might be graded “High.” An example of an attribute that is evaluated on an absolute scale might be a “Construction Type” value wherein: “Frame” and “Veneer” construction types might be classified as “Ordinary;” and Joisted Masonry, Non-Combustible, Masonry Non-Combustible and Superior Non-Combustible construction types might be classified as “Moderate.” Another example might be a “Fire Protection Class” value wherein: Fire Protection Class Codes of 7 or less might be classified as “Protected;” and Fire Protection Class Codes of 8, 9, and 10 might be considered “Unprotected.”

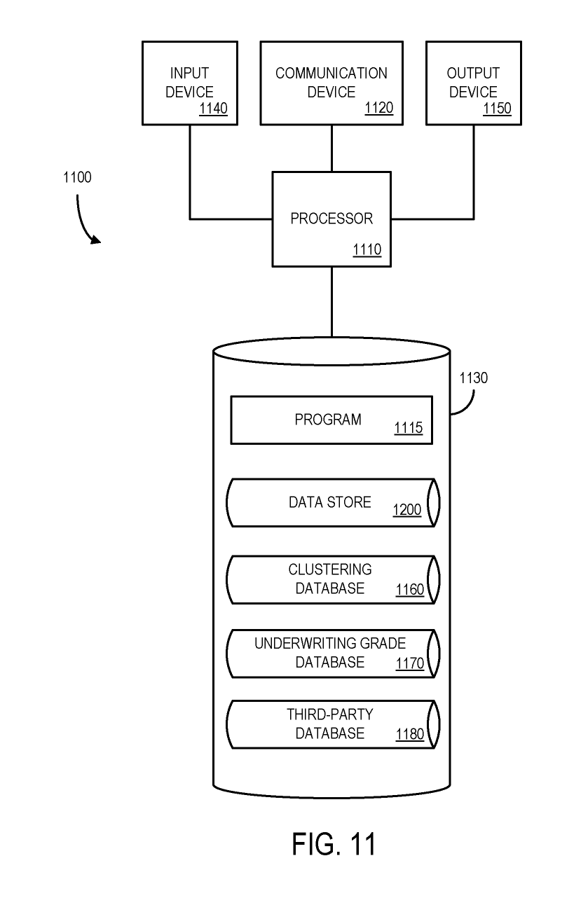

The embodiments described herein may be implemented using any number of different hardware configurations. For example, FIG. 11 illustrates a back-end application computer server 1100 that may be, for example, associated with the systems 100, 400 described with respect to FIGS. 1 and 4, respectively. The back-end application computer server 1100 comprises a processor 1110, such as one or more commercially available Central Processing Units (“CPUs”) in the form of one-chip microprocessors, coupled to a communication device 1120 configured to communicate via a communication network (not shown in FIG. 11). The communication device 1120 may be used to communicate, for example, with one or more remote administrator computers and or communication devices (e.g., PCs and smartphones). Note that communications exchanged via the communication device 1120 may utilize security features, such as those between a public intern& user and an internal network of the insurance enterprise. The security features might be associated with, for example, web servers, firewalls, and/or PCI infrastructure. The back-end application computer server 1100 further includes an input device 1140 (e.g., a mouse and/or keyboard to enter information about properties, mapping data, historic information, predictive models, etc.) and an output device 1150 (e.g., to output reports regarding underwriting decisions and recommendations).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1115 and/or a risk evaluation tool or application for controlling the processor 1110. The processor 1110 performs instructions of the program 1115, and thereby operates in accordance with any of the embodiments described herein. For example, a data store may contain electronic records representing a plurality of potential associations and, for each potential association, an electronic record identifier and a set of attribute values. An automated electronic record classification computer may classify electronic records from the data store into sub-sets of related records. An automated scoring analysis computer may retrieve, for each electronic record in a classified sub-set, the set of attribute values and calculate at least one attribute analysis score (based on attribute values of other electronic records in the same sub-set). The processor 1110 may retrieve attribute values along with an attribute analysis score associated with an electronic record of interest and automatically retrieve third-party data. Data associated with an interactive user interface display, including the at least one attribute analysis score and the third-party data, may then be transmitted by the processor 1110 via a distributed communication network.

The program 1115 may be stored in a compressed, uncompiled and/or encrypted format. The program 1115 may furthermore include other program elements, such as an operating system, a database management system, and/or device drivers used by the processor 1110 to interface with peripheral devices.

As used herein, information may be “received” by or “transmitted” to, for example: (i) the back-end application computer server 1100 from another device; or (ii) a software application or module within the back-end application computer server 1100 from another software application, module, or any other source.

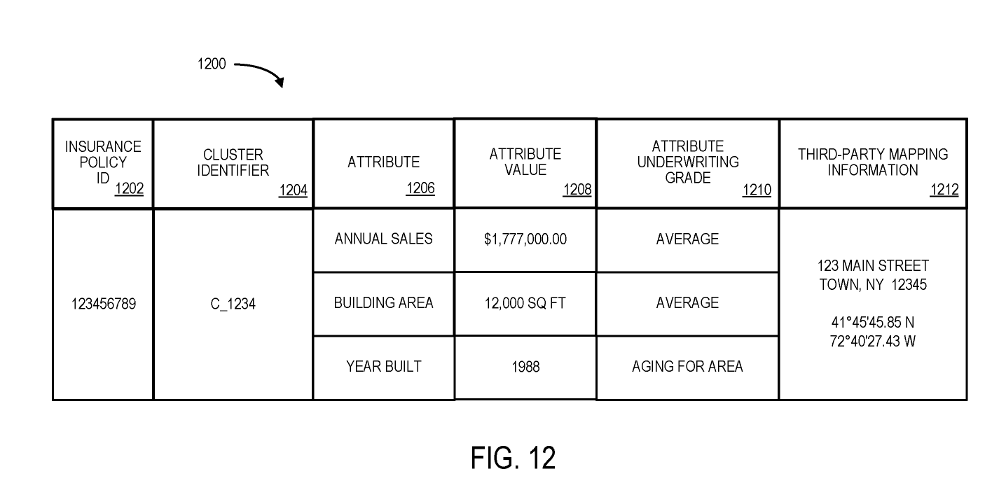

In some embodiments (such as shown in FIG. 11), the storage device 1130 further stores a computer data store 1200 (e.g., associated with a set of destination communication addresses, attribute variables, etc.), a clustering database 1160, an underwriting grade database 1170, and a third-party database 1180. Examples of databases that might be used in connection with the back-end application computer server 1100 will now be described in detail with respect to FIG. 12. Note that the database described herein is only an example, and additional and/or different information may be stored therein. Moreover, various databases might be split or combined in accordance with any of the embodiments described herein. For example, the computer data store 1200 and/or clustering database 1160 might be combined and/or linked to each other within the program 1115.

Referring to FIG. 12, a table is shown that represents the computer data store 1200 that may be stored at the back-end application computer server 1100 according to some embodiments. The table may include, for example, entries associated with properties to be evaluated by an underwriter. The table may also define fields 1202, 1204, 1206, 1208, 1210, 1212 for each of the entries. The fields 1202, 1204, 1206, 1208, 1210, 1212 may, according to some embodiments, specify: an insurance policy identifier 1202, a cluster identifier 1204, an attribute 1206, an attribute value 1208, an attribute value score 1210, and mapping 1212. The computer data store 1200 may be created and updated, for example, based on information electrically received from various computer systems, including third-party mapping applications.

The insurance policy identifier 1202 may be, for example, a unique alphanumeric code identifying an insurance policy that may be reviewed by an underwriter. According to some embodiments, the insurance policy identifier 1202 might be associated with the insurance policy number search box 322 described with respect to FIG. 3. The cluster identifier 1204 may, according to some embodiments, identify a sub-set of other insurance policies that share similar characteristics with the policy identifier 1202 (e.g., geographic and/or other characteristics). The attribute 1206 may represent a type of parameter associated with the policy identifier 1202 (e.g., annual sales, building area, year built, etc.). The attribute value 1208 may represent the actual value of the attribute 1206 (e.g., as determined during an insurance policy quote process). The attribute value score 1210 might represent, for example, a grade, category, numerical value, rank, etc. indicating an amount of risk that might be associated with the policy identifier 1202 with respect to that particular attribute 1206. The mapping data 1212 might represent, according to some embodiments, a street address, latitude and longitude values, etc. associated with a third-party mapping service and/or API.

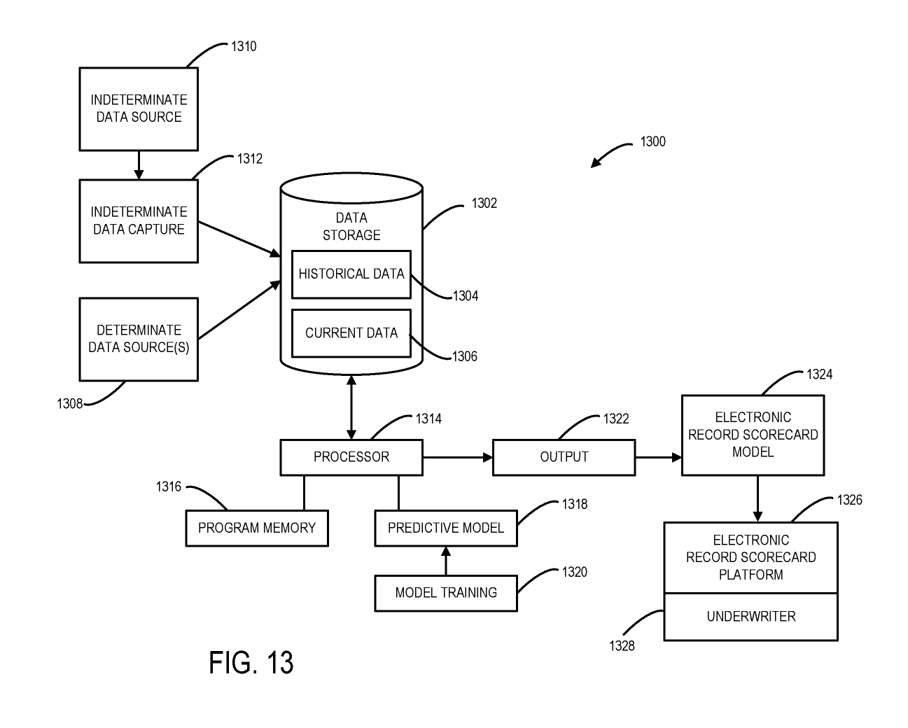

According to some embodiments, one or more predictive models may be used to predict or forecast future events. Features of some embodiments associated with a predictive model will now be described by first referring to FIG. 13. FIG. 13 is a partially functional block diagram that illustrates aspects of a computer system 1300 provided in accordance with some embodiments of the invention. For present purposes it will be assumed that the computer system 1300 is operated by an insurance company (not separately shown) for the purpose of supporting an insurance underwriting process (e.g., to help accurately make decisions regarding insurance premiums, coverages, etc.).

The computer system 1300 includes a data storage module 1302. In terms of its hardware the data storage module 1302 may be conventional, and may be composed, for example, by one or more magnetic hard disk drives. A function performed by the data storage module 1302 in the computer system 1300 is to receive, store and provide access to both historical transaction data (reference numeral 1304) and current transaction data (reference numeral 1306). As described in more detail below, the historical transaction data 1304 is employed to train a predictive model to provide an output that indicates an identified performance metric and/or an algorithm to score performance factors, and the current transaction data 1306 is thereafter analyzed by the predictive model. Moreover, as time goes by, and results become known from processing current transactions (e.g., underwriting, clustering, and/or attribute grading decisions), at least some of the current transactions may be used to perform further training of the predictive model. Consequently, the predictive model may thereby appropriately adapt itself to changing conditions.

Either the historical transaction data 1304 or the current transaction data 1306 might include, according to some embodiments, determinate and indeterminate data. As used herein and in the appended claims, “determinate data” refers to verifiable facts such as the an age of a building; a property size; a policy date or other date; a driver age; a time of day; a day of the week; a geographic location, address or ZIP code; and a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files.

The determinate data may come from one or more determinate data sources 1308 that are included in the computer system 1300 and are coupled to the data storage module 1302. The determinate data may include “hard” data like an insured or claimant name, type of business, industry classification code, policy number, address, an underwriter decision, etc. One possible source of the determinate data may be the insurance company's insurance policy database (not separately indicated).

The indeterminate data may originate from one or more indeterminate data sources 1310, and may be extracted from raw files or the like by one or more indeterminate data capture modules 1312. Both the indeterminate data source(s) 1310 and the indeterminate data capture module(s) 1312 may be included in the computer system 1300 and coupled directly or indirectly to the data storage module 1302. Examples of the indeterminate data source(s) 1310 may include data storage facilities for document images, for text files, and digitized recorded voice files. Examples of the indeterminate data capture module(s) 1312 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an individual.

The computer system 1300 also may include a computer processor 1314. The computer processor 1314 may include one or more conventional microprocessors and may operate to execute programmed instructions to provide functionality as described herein. Among other functions, the computer processor 1314 may store and retrieve historical insurance transaction data 1304 and current transaction data 1306 in and from the data storage module 1302. Thus the computer processor 1314 may be coupled to the data storage module 1302.

The computer system 1300 may further include a program memory 1316 that is coupled to the computer processor 1314. The program memory 1316 may include one or more fixed storage devices, such as one or more hard disk drives, and one or more volatile storage devices, such as RAM devices. The program memory 1316 may be at least partially integrated with the data storage module 1302. The program memory 1316 may store one or more application programs, an operating system, device drivers, etc., all of which may contain program instruction steps for execution by the computer processor 1314.

The computer system 1300 further includes a predictive model component 1318. In certain practical embodiments of the computer system 1300, the predictive model component 1318 may effectively be implemented via the computer processor 1314, one or more application programs stored in the program memory 1316, and computer stored as a result of training operations based on the historical transaction data 1304 (and possibly also data received from a third party). In some embodiments, data arising from model training may be stored in the data storage module 1302, or in a separate computer store (not separately shown). A function of the predictive model component 1318 may be to determine appropriate underwriting, clustering, and/or attribute grading decisions for one or more potential insurance policies. The predictive model component may be directly or indirectly coupled to the data storage module 1302.

The predictive model component 1318 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 1300 includes a model training component 1320. The model training component 1320 may be coupled to the computer processor 1314 (directly or indirectly) and may have the function of training the predictive model component 1318 based on the historical transaction data 1304 and/or information about potential insureds. (As will be understood from previous discussion, the model training component 1320 may further train the predictive model component 1318 as further relevant data becomes available.) The model training component 1320 may be embodied at least in part by the computer processor 1314 and one or more application programs stored in the program memory 1316. Thus, the training of the predictive model component 1318 by the model training component 1320 may occur in accordance with program instructions stored in the program memory 1316 and executed by the computer processor 1314.

In addition, the computer system 1300 may include an output device 1322. The output device 1322 may be coupled to the computer processor 1314. A function of the output device 1322 may be to provide an output that is indicative of (as determined by the trained predictive model component 1318) particular clustering, attribute grade, and/or underwriting decisions, etc. The output may be generated by the computer processor 1314 in accordance with program instructions stored in the program memory 1316 and executed by the computer processor 1314. More specifically, the output may be generated by the computer processor 1314 in response to applying the data for the current simulation to the trained predictive model component 1318. The output may, for example, be a numerical estimate and/or likelihood within a predetermined range of numbers. In some embodiments, the output device may be implemented by a suitable program or program module executed by the computer processor 1314 in response to operation of the predictive model component 1318.

Still further, the computer system 1300 may include an electronic record scorecard model module 1324. The electronic record scorecard model module 1324 may be implemented in some embodiments by a software module executed by the computer processor 1314. The electronic record scorecard model module 1324 may have the function of rendering a portion of the display on the output device 1322 (e.g., an interactive user display including attribute grades, mapping information, geo cohort data, etc.). Thus, the electronic record scorecard model module 1324 may be coupled, at least functionally, to the output device 1322. In some embodiments, for example, the electronic record scorecard model module 1324 may report results and/or predictions by routing, to an underwriter 1328 via an electronic record scorecard platform 1326, mapping information and/or automatically generated, cluster-based attribute scores generated by the predictive model component 1318. In some embodiments, this information may be provided to an underwriter 1328 who may also be tasked with determining whether or not the results may be improved (e.g., by further adjusting models).

In some embodiments described herein, a predictive model may use information obtained during an insurance quote process (e.g., describing a property, a type of business, etc.) to assign a potential insurance policy to an appropriate cluster and/or generate one or more attribute grades. Note, however, that a predictive model may receive other inputs and/or generate other embodiments in accordance with embodiments described herein. For example, a predictive model might receive historic claim information (e.g., associated with other insurance policies within a cluster). According to some embodiments, the predictive model might be run using several different alternate sets of input values and generate predication for each of those scenarios.

Thus, embodiments may provide an automated and efficient way to generate attribute analysis scores for a potential insurance policy to help an underwriter make better decisions. Embodiments may also address the need for a consistent and objective determination of how a potential insurance policy should be evaluated.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

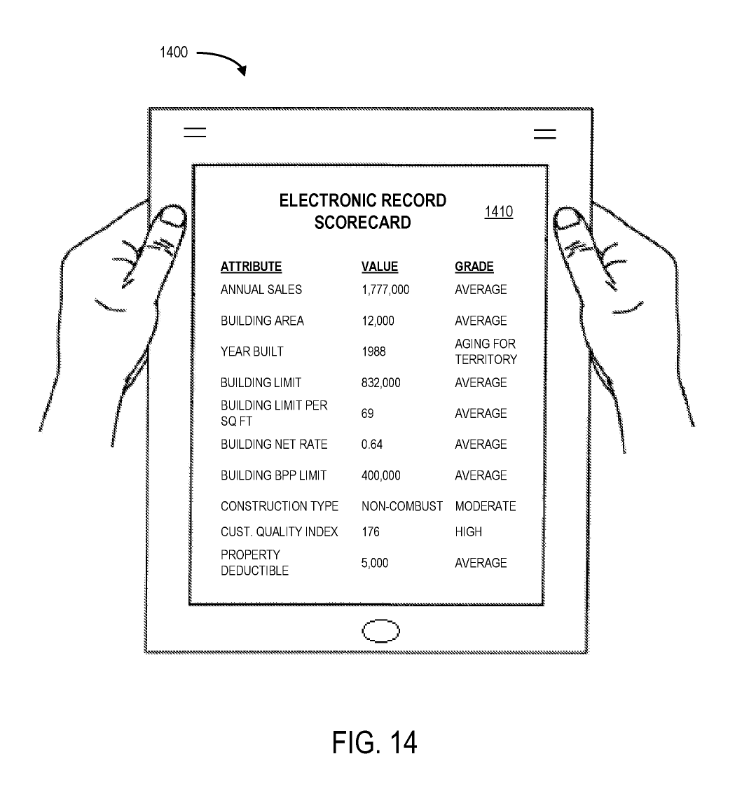

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, embodiments may instead be associated with other types of insurance policies in additional to and/or instead of the policies described herein (e.g., business insurance policies, automobile insurance policies, etc.). Similarly, although a certain number of attribute grades and/or levels of geographic cohorts were described in connection some embodiments herein, other numbers of grades and/or cohort levels might be used instead. Still further, the displays and devices illustrated herein are only provided as examples, and embodiments may be associated with any other types of user interfaces. For example, FIG. 14 illustrates a handheld tablet computer 1400 displaying an attribute values and grades display 1410 according to some embodiments. The attribute values and grades display 1410 might include user-selectable data that can be selected and/or modified by a user of the handheld computer 1400.

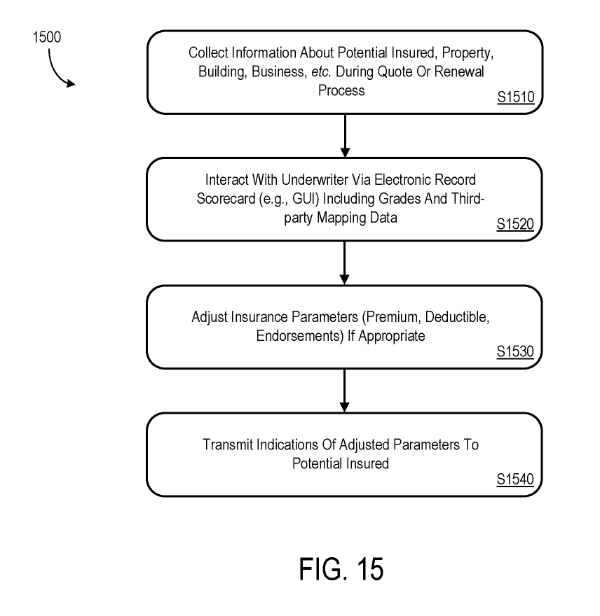

FIG. 15 illustrates an overall process 1500 in accordance with some embodiments. At S1510, information about a potential insured, property, building, business, etc. may be collected during an insurance quote or renew process. This information might be gathered, for example, via an interview, telephone call, web-based form, etc. At S1520, the system may interact with an underwriter via an electronic record scorecard (e.g., associated with an interactive GUI), including attribute grades and/or third-party mapping data. The attribute grades might compare the insured or the property being evaluated with similar insureds and/or properties (e.g., geographic clusters or cohorts) to help the underwriter better understand the risks associated with the potential insurance policy. Similarly, the mapping data may provide some context for the underwriter as he or she makes decisions about the potential insurance policy. For example, at S1530 the underwriter may adjust one or more insurance policy parameters, such as a premium, deductible, endorsements, etc. if appropriate based on the levels of risk associated with the insured and/or property. Indications of the adjusted parameters may then be transmitted to the potential insured at S1540 (e.g., via an agent, web page, telephone call, etc.). In this way, appropriate insurance policy parameters may be assigned to a potential insurance policy as appropriate in view of an insured, property, industry, etc. Note that the indications of the adjusted parameters made by an underwriter might be transmitted directly to the potential insured or instead be provided via an insurance agent, a sales representative, a customer service manager, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to automatically generate attribute analysis scores for an enterprise system via an automated back-end application computer server, comprising:
(a) a data store containing electronic records representing a plurality of potential associations with the enterprise and, for each potential association, an electronic record identifier and a set of attribute values;
(b) an automated electronic record classification computer, coupled to the data store, programmed to:
(i) classify electronic records from the data store into sub-sets of related records, the classification being based on at least one attribute identifier and at least one granularity level, and
(ii) store indications of the classified sub-sets of related records;
(c) an automated scoring analysis computer, coupled to the data store, programmed to:
(iii) retrieve, for each electronic record in a classified sub-set, the associated set of attribute values,
(iv) calculate at least one attribute analysis score for each electronic record based on sets of attribute values associated with other electronic records classified in the same sub-set, and
(v) store an indication of the attribute analysis score for each electronic record;
(d) the back-end application computer server, coupled to the data store, programmed to:
(vi) receive an indication of an electronic record of interest,
(vii) access the data store to retrieve the set of attribute values along with the at least one attribute analysis score associated with the electronic record of interest, and
(viii) automatically retrieve third-party data based at least in part on the electronic record of interest; and
(e) a communication port coupled to the back-end application computer server to facilitate a transmission of data associated with an interactive user interface display, including the at least one attribute analysis score and the third-party data, via a distributed communication network.

2. The system of claim 1, wherein said classification of electronic records into sub-sets of related records is performed in accordance with a clustering process based on an attribute identifier and a granularity level selected via the interactive user interface display.

3. The system of claim 2, wherein the clustering process is associated with a k-means clustering machine learning algorithm.

4. The system of claim 3, wherein each electronic record is associated with a potential insurance policy and the at least one attribute analysis score comprises an underwriting grade.

5. The system of claim 4, wherein each potential insurance policy is associated with at least one of: (i) an insurance policy quote, (ii) an existing insurance policy, and (iii) an insurance policy renewal.

6. The system of claim 4, wherein the indication of the electronic record of interest is associated with an insurance policy search input.

7. The system of claim 6, wherein the insurance policy search input is associated with at least one of: (i) an insurance policy number, (ii) a selected location, (iii) an insured name, (iv) an insurance policy description, and (v) a building identifier.

8. The system off claim 4, wherein the selected granularity level is associated with at least one of: (i) a geographic cohort granularity, (ii) an insurance agency granularity, (iii) a state granularity, and (iv) a market group granularity.

9. The system of claim 4, wherein at least one of the attribute values comprises information about the insured associated with the insurance policy, including at least one of: (i) an annual sales amount, (ii) an industry classification, and (iii) prior claim information.

10. The system of claim 4, wherein at least one of the attribute values comprises information about the insurance policy, including at least one of: (i) a property deductible amount, (ii) a business personal property limit, (iii) a building limit, and (iv) a building limit per square foot.

11. The system of claim 4, wherein at least one of the attribute values comprises information about a property associated with the insurance policy, including at least one of: (i) a building area, (ii) a building net rate, (iii) a construction type, (iv) a fire protection class, and (v) a year built.

12. The system of claim 4, wherein at least one of the attribute values comprises information about a location associated with the insurance policy, including at least one of: (i) a quality index, (ii) an earthquake zone, (iii) a wind zone, and (iv) a sub-wind zone.

13. The system of claim 4, wherein the third party data comprising mapping data accessed via an application programming interface.

14. The system of claim 13, wherein the interactive user interface display includes an interactive street level map dynamically created from the third party data and is further adapted to provide at least one of: (i) a plurality of benchmarking graphs, (ii) a virtual tour, (iii) social media information, (iv) document text explaining at least one underwriting grade, (v) satellite image map information, and (vi) an interactive cluster display that can be adjusted by a user.

15. A computerized method to automatically generate attribute analysis scores for an enterprise system via an automated back-end application computer server, comprising:
accessing, by an automated electronic record classification computer, a data store containing electronic records representing a plurality of potential associations with the enterprise and, for each potential association, an electronic record identifier and a set of attribute values;
classifying, by the automated electronic record classification computer, electronic records into sub-sets of related records, the classification being based on at least one attribute identifier and at least one granularity level;
storing, by the automated electronic record classification computer, indications of the classified sub-sets of related records;
retrieving, by an automated scoring analysis computer for each electronic record in a classified sub-set, the associated set of attribute values;
calculating, by the automated scoring analysis computer, at least one attribute analysis score for each electronic record based on sets of attribute values associated with other electronic records classified in the same sub-set;
storing, by the automated scoring analysis computer, an indication of the attribute analysis score for each electronic record;
receiving, by the back-end application computer server, an indication of an electronic record of interest;
accessing, by the back-end application computer server, the data store to retrieve the set of attribute values along with the at least one attribute analysis score associated with the electronic record of interest;
automatically retrieving, by the back-end application computer server, third-party data based at least in part on the electronic record of interest; and
transmitting, by the back-end application computer server via a communication port, data associated with an interactive user interface display, including the at least one attribute analysis score and the third-party data, via a distributed communication network.

16. The method of claim 15, wherein said classification of electronic records into sub-sets of related records is performed in accordance with a clustering process based on an attribute identifier and a granularity level selected via the interactive user interface display, the clustering process comprising a k-means clustering machine learning algorithm.

17. The method of claim 16, wherein each electronic record is associated with a potential insurance policy and the at least one attribute analysis score comprises an underwriting grade.

18. The method of claim 17, wherein the indication of the electronic record of interest is associated with an insurance policy search input comprising at least one of: (i) an insurance policy number, (ii) a selected location, (iii) an insured name, (iv) an insurance policy description, and (v) a building identifier.

19. The method off claim 17, wherein the selected granularity level is associated with at least one of: (i) a geographic cohort granularity, (ii) an insurance agency granularity, (iii) a state granularity, and (iv) a market group granularity.

20. The method of claim 17, wherein at least one of the attribute values comprises (i) information about the insured associated with the insurance policy, (ii) an annual sales amount, (iii) an industry classification, (iv) prior claim information, (v) information about the insurance policy, (vi) a property deductible amount, (vii) a business personal property limit, (viii) a building limit, (ix) a building limit per square foot, (x) information about a property associated with the insurance policy, (xi) a building area, (xii) a building net rate, (xiii) a construction type, (xiv) a fire protection class, (xv) a year built, (xvi) information about a location associated with the insurance policy, (xvii) a quality index, (xviii) an earthquake zone, (xix) a wind zone, and (xx) a sub-wind zone.

21. The method of claim 15, further comprising, prior to said accessing of the data store containing the electronic records:
collecting information about the plurality of potential associations with the enterprise, including data about a business and a building comprising a potential insured, during an insurance quote process; and
storing the collected information into electronic records of the computer store.

22. The method of claim 21, further comprising, after said transmitting of the data associated with the interactive user interface display:
receiving from an underwriter device an adjusted insurance parameter; and
facilitating receipt of the adjusted insurance parameter by the potential insured.

23. A non-tangible, computer-readable medium storing instructions, that, when executed by a processor, cause the processor to perform a method to automatically generate attribute analysis scores for an enterprise system via an automated back-end application computer server, the method comprising:
accessing, by an automated electronic record classification computer, a data store containing electronic records representing a plurality of potential associations with the enterprise and, for each potential association, an electronic record identifier and a set of attribute values;
classifying, by the automated electronic record classification computer, electronic records into sub-sets of related records, the classification being based on at least one attribute identifier and at least one granularity level;
storing, by the automated electronic record classification computer, indications of the classified sub-sets of related records;
retrieving, by an automated scoring analysis computer for each electronic record in a classified sub-set, the associated set of attribute values;
calculating, by the automated scoring analysis computer, at least one attribute analysis score for each electronic record based on sets of attribute values associated with other electronic records classified in the same sub-set;
storing, by the automated scoring analysis computer, an indication of the attribute analysis score for each electronic record;
receiving, by the back-end application computer server, an indication of an electronic record of interest;
accessing, by the back-end application computer server, the data store to retrieve the set of attribute values along with the at least one attribute analysis score associated with the electronic record of interest;
automatically retrieving, by the back-end application computer server, third-party data based at least in part on the electronic record of interest; and
transmitting, by the back-end application computer server via a communication port, data associated with an interactive user interface display, including the at least one attribute analysis score and the third-party data, via a distributed communication network.

24. The medium of claim 23, wherein said classification of electronic records into sub-sets of related records is performed in accordance with a clustering process based on an attribute identifier and a granularity level selected via the interactive user interface display, the clustering process comprising a k-means clustering machine learning algorithm.

25. The medium of claim 24, wherein each electronic record is associated with a potential insurance policy and the at least one attribute analysis score comprises an underwriting grade.
